(19) United States
(12) Patent Application Publication
(10) Pub. No.: US 2025/0141480 A1
(43) Pub. Date: May 1, 2025

(54) METHOD AND SYSTEM FOR ACTIVE CALIBRATION AND/OR LINEARIZATION OF ANTENNA ARRAYS

(71) Applicant: Slim BOUMAIZA, Waterloo (CA)

(72) Inventors: Slim BOUMAIZA, Waterloo (CA); Huixin JIN, Waterloo (CA); Ahmed Ben AYED, Waterloo (CA)

(21) Appl. No.: 18/383,985

(22) Filed: Oct. 26, 2023

(51) Int. Cl. H04B 1/04; H04B 7/06

(52) U.S. Cl. CPC H04B 1/0475; H04B 7/0617

(57) ABSTRACT

The disclosure is directed a methods and system for calibration and/or linearization of an antenna array. Signals radiated by the antenna array captured by near-field (NF) probes are processed by the system to generate calibration and/or linearization parameters which are then used to control the antenna array.

### FIELD

The present disclosure is generally directed at wireless and satellite communication systems and, more specifically, at a method and system for active calibration and/or linearization of antenna arrays.

### BACKGROUND

Antenna arrays represent a pivotal technological component within wireless and satellite communication systems, however, they are susceptible to both linear and non-linear distortions, which can impair their performance. Linear distortions may originate from various sources, including, but not limited to, manufacturing tolerances, circuit parasitics, electromagnetic coupling, frequency-dependent behavior, and inadequate thermal management. Signals propagated through each radio frequency (RF) path within an antenna array experience variations in magnitude, phase and/or time delays that affect array-level performance resulting in a deteriorated radiation pattern and/or effective isotropic radiated power (EIRP). These signals may also be subjected to significant non-linear distortions, typically exhibited by the power amplifier stages. These non-linear distortions can compromise or affect the ability of the antenna array to comply with spectrum emissions regulations and quality of signal requirements.

Characterization and compensation, which may be seen as calibration, of the linear distortions exhibited by the antenna array may be performed to achieve acceptable radiation performance. In addition, linearization methods, such as digital pre-distortion, can be used to compensate for the nonlinearity exhibited by the antenna array. Currently, the calibration and linearization of antenna arrays are typically performed in an in-lab setting using feedback signal(s) acquired by external equipment such as far-field (FF) probing equipment. However, such methods and equipment are not suitable for in-field deployment where the necessary external equipment cannot be accessible.

Therefore, there is a provided a novel method and system for active calibration and/or linearization of antenna arrays

### SUMMARY

This disclosure is directed at methods and systems for active calibration and/or linearization for an antenna array using near-field (NF) probes. In one embodiment, the disclosure may include a set of NF probes, a post-processing component, and a controller. The NF probes may be co-located with the antenna array (e.g., embedded within the antenna array or in its vicinity). Outputs from the NF probes may be connected to the post-processing component that may be implemented using arrangements of, but not limited to, switches, power dividers/combiners, and couplers. The controller is configured to control the antenna array and the post-processing component to acquire the necessary characterization data and compute the calibration and linearization parameters or signals.

In one aspect of the disclosure, there is provided an apparatus for active calibration and/or linearization of an antenna array including a set of near-field (NF) probes located proximate the antenna array to receive analog antenna array signals transmitted by the antenna array; and a controller for calculating at least one of calibration signals or linearization signals based on digital equivalents of the analog antenna array signals and for controlling the antenna array based on the least one of the calibration signals or linearization signals.

In another aspect, the apparatus includes a processing unit for processing the analog antenna array signals to generate digital equivalents of the analog antenna array signal and to pass the digital equivalents of the analog antenna array signals to the controller. In yet another aspect, the apparatus further includes an analog precoder for receiving calibration signals to control the antenna array. In a further aspect, the apparatus includes a digital predistortion module for receiving the linearization signals and for generating at least one predistortion signal based on the linearization signals; wherein the predistortion signal is transmitted to the analog precoder to update the calibration signals. In another aspect, the apparatus includes a digital precoder. In yet a further aspect, the processing includes at least one of combiners, dividers, switches, analog-to-digital converters (ADCs) or couplers.

In another aspect of the disclosure, there is provided a method of active calibration and/or linearization of an antenna array including receiving, via a set of near-field probes, a set of analog antenna signals; and calculating at least one of calibration signals or linearization signals based on digital equivalents of the analog antenna array signals and for controlling the antenna array based on the least one of the calibration signals or linearization signals.

In another aspect, the method includes, after receiving the set of analog antenna signals, processing the set of analog antenna signals to generate the digital equivalents of the analog antenna array signals. In a further aspect, the method includes transmitting the calibration signals to an analog precoding component to control the antenna array. In yet another aspect, the method includes calculating non-linear antenna array signals based on the linearization signals. In yet a further aspect, the method includes transmitting the non-linear antenna array signals to an analog precoding component to control the antenna array.

### DESCRIPION OF THE DRAWINGS

Some embodiments of the present disclosure are illustrated as an example and are not limited by the figures of the accompanying drawings, in which like references may indicate similar elements and in which:

FIG. 1 is a block diagram of a first embodiment of a radio-frequency (RF) beamforming-based antenna array system utilizing near-field (NF) probes for calibration and/or linearization;

FIG. 2 is a block diagram of another embodiment of a beamforming-based array system utilizing NF probes for calibration and/or linearization;

FIG. 3 is a block diagram of a further embodiment of a beamforming-based array system utilizing NF probes for calibration and/or linearization;

FIG. 4a is a flowchart showing a method of active calibration and/or linearization for an antenna array using NF probes;

FIG. 4b is a flowchart showing another method of active calibration and/or linearization for an antenna array using NF probes; and

FIG. 5 is a block diagram of one embodiment of NF probes co-located with an antenna array.

### DESCRIPTION OF THE EMBODIMENTS

The present disclosure pertains to methods and systems for the active calibration and/or linearization of antenna arrays using near-field (NF) probes. In one embodiment, NF probes are located proximate to an antenna array (which includes a set of radio-frequency (RF) chains) to receive a sample of the signals (seen as antenna signals) radiated from the antenna array. These samples and/or the signals are subsequently processed for the purpose of calibrating and/or linearizing the antenna array. In one embodiment, the calibration process is performed simultaneously on each of the set of RF chains or antennas.

In another embodiment, the disclosure is directed at a method and system for active array calibration and/or linearization of a RF beamforming-based antenna array. Within this embodiment, the disclosure includes the acquisition of a series of characterization data (such as the samples of signals radiated from the antenna array) acquired through NF probes that are located proximate to the antenna array. In one embodiment, the characterization data is acquired for different phase settings that are based on orthogonal coding techniques or alternative established methods, thereby enabling the comprehensive characterization of linear and/or non-linear errors inherent in the RF chains of the array.

Yet, another embodiment of the disclosure is directed at a method and system for active array calibration and/or linearization of beamforming antenna, encompassing RF, hybrid, and digital beamforming arrays. Within this embodiment, NF probes located proximate the array are used to acquire a set or series of characterization data. These data are acquired for different, analog and/or digital beamforming settings that are based on orthogonal coding techniques or other known approaches, thereby enabling the comprehensive characterization of linear and/or non-linear errors inherent in the RF chains of the array.

In another embodiment, the controller configures the antenna array with a predetermined set of settings pertaining to the RF chains, including analog and/or digital beamforming settings. These settings may be determined based on orthogonal coding or other recognized approaches. Additionally, the controller configures the post-processing component and leverages its output(s) for the computation of calibration and/or linearization parameters.

The input signal(s) used during the training phase of the calibration and/or linearization may be single-tone or multi-tone signal(s), or modulated signal(s) where the modulation process may adjust the amplitude, frequency, and/or phase of the signal(s). Furthermore, these input signal(s) may occupy narrow or wide bandwidth(s).

Advantages of the current disclosure include, but are not limited to, an enhanced radiation pattern and an increase in effective isotropic radiation power (EIRP) while maintaining a low error vector magnitude. Another advantage is the absence of a requirement for flat coupling between the NF probes and the RF chains' outputs.

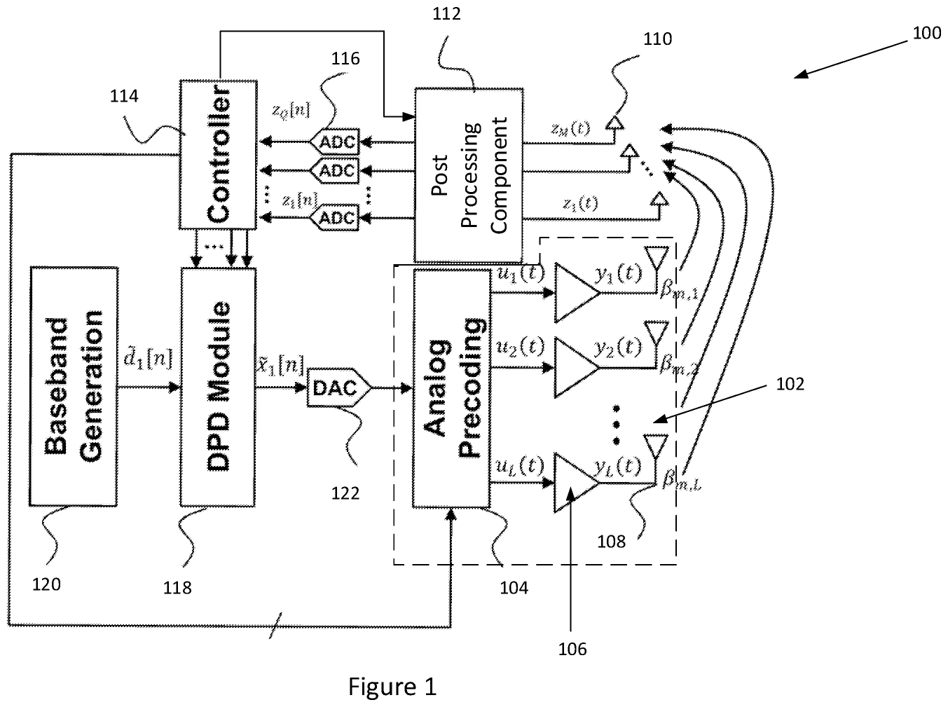

Turning to FIG. 1, a block diagram of an RF beamforming-based antenna array system with NF probes is shown. Signals sensed or received by the NF probes, or coupled with the NF probes are used for the active calibration and/or linearization of the antenna array.

The RF beamforming based antenna array system 100 includes an RF front-end 102 that includes an analog precoding component 104, power amplifiers 106 and antennas 108. The analog precoding component 104 may include components such as power dividers, combiners, gain circuitry and phase control circuitry, for receiving, processing and/or transmitting signals, however, other components are also contemplated. Positioned in proximity to the set of antennas 108 (which may be seen an antenna array) are a set of NF probes 110 for sensing samples of signals or the signals themselves (seen collectively as antenna signals) radiated by the antennas 108. The system 100 further includes a post-processing component 112 that processes the antenna signals and then transmits or passes them to a controller 114 via a set of analog-to-digital converters (ADC) 116. Although multiple ADCs 116 are shown in a one-to-one relationship with the number of NF probes 110, it is understood that the ratio of ADCs 116 to NF probes may not be one-to-one. The ADCs 116 convert the analog antenna signals from the NF probes 110 into their digital equivalents before they are transmitted or passed to the controller 114. In some embodiments, the post-processing component 112 may include the ADCs 116 whereby the post-processing component 112 performs the analog to digital conversion of the antenna signals.

In some embodiments, the post-processing component 112 directs the antenna signals from the NF probes 110 towards one of the ADCs 116 for the conversion of the signals. In other words, the post-processing component 112 provides a transmission path for antenna signals from the NF probes 110 to the ADCs 116. In some embodiments, the post-processing component 112 may perform some processing on the antenna signals such they are in a format that can be received by the ADCs 116. The type of processing may be determined via signals received from the controller 114. This processing may result in the output or outputs of the post- processing component 112 at a specific RF, at an intermediate frequency (IF), or may be in-phase (I) and quadrature (Q) baseband signal(s) based on requirements of the controller 114 and/or system. Depending on the implementation of the post-processing component 112, the component 112 may have one or more distinct outputs.

In one embodiment, the post-processing component 112 may be implemented via a combination of one or more combiners/dividers, switches, ADCs and/or couplers. As discussed above, in embodiments where the post-processing component 112 includes ADCs, there is no need for ADCs 116. In other embodiments, the NF probes 110 may be connected directly to the controller 114 or connected to the controller 114 via the ADCs 116.

The controller 114 may include at least one of a processor, random access memory (RAM), non-volatile memory, a display device, an input device, and an I/O interface for controlling the antenna array 108 and the post-processing component 112. The controller 114 may also include data storage on which one or more programs or software components may be stored. For example, the data storage may contain one or more programs that are executable to perform the methods described herein. The data storage may also store operating system software, as well as other software for the operation of the controller 114. Various embodiments further include receiving or sending string instructions and/or data.

In specific embodiments, the controller 114 may perform computation of the calibration and/or linearization parameters. The controller 114 may also perform a NF to FF or NF to power amplifier outputs reconstruction method as described herein

In the current embodiment, the controller 114 is interconnected with the analog precoding component 104 to define its settings during the calibration process. In the current embodiment, the controller 114 is also connected to a digital pre-distortion (DPD) module 118 that generates the predistorted signal. Furthermore, the controller 114 is connected to the post-processing component 112 to configure its output(s) and to receive those outputs. A baseband generation component 120 is also connected to the DPD module 116. The DPD module 116 is connected to the analog precoding component 104 via a digital-to-analog converter (DAC) 122 which converts the continuous-time predistorted signal generated by the DPD module 118 to its analog equivalent.

In operation, antenna signals that are transmitted by the different radiating antennas 108 are coupled to at least one of the set of NF probes 110 or received by the set of NF probes 110. These antenna signals are then fed to the post-processing component 112 and passed on to the controller 114. The post-processing component 112 may perform a variety of functions on the antenna signals depending on a design of the system 100. In some embodiments, the post-processing component may digitize the analog antenna signals of the NF probes into their digital equivalents. The post-processing component 112 may also receive all of the antenna signals coupled to the set of NF probes 100 and may then transmit a predetermined number of the coupled antenna signals to the controller 114 based on requirements received from the controller 114. In most embodiments, the controller 114 will receive all of the digital antenna signals, although in other embodiments, it may only require a select number of the digital antenna signals. The post-processing component 112 may also perform other types of processing on the analog antenna signals before or after they are processed into their digital equivalents.

After receiving the digitized antenna signals, the controller 114 processes these signals to calculate or determine calibration and/or linearization parameters for controlling the antennas 108 via the analog precoding component 104.

In one embodiment, the controller 114 configures the analog precoding component by transmitting a set or series of settings or settings signals. These may also be seen as calibration signals, or calibration parameters and/or linearization signals or linearization parameters. The setting signals may be based on orthogonal coding techniques or alternative established methods. This will be described in more detail below. Concurrently, the NF probes 110 capture or receive a series of characterization data signals (which may also be seen as the analog antenna signals) radiated by the antennas 108 based on, or in response to, the setting signals.

The characterization data is then routed back to the controller 104 through the post-processing component 112. The controller 114 uses the characterization data to compute the calibration and/or linearization parameters for controlling the antennas based on the information provided via the characterization data. In one embodiment, this process is iteratively repeated until a desired calibration and/or linearization performance (as determined based on the received characterization data or antenna signals) is achieved.

In another embodiment, the controller 114 may perform a NF to FF or NF to power amplifier outputs 106 reconstruction methods. The resulting reconstruction data (sensed by the NF probes and transmitted the controller) is then used to characterize the linear and/or nonlinear distortions in the antenna array.

The calibration and/or linearization parameters, as computed by the controller 114, are subsequently employed by the controller 114 to perform the calibration of the analog precoding component 104 by adjusting its control word. Additionally, the linearization parameters are relayed to the DPD module 118, where the parameters are used or processed to generate the pre-distorted signal. The pre-distorted signal may be used by the RF front end 102 as compensation for nonlinear distortions. Further details regarding operation of the disclosure are discussed below.

With respect to the following description, the subscript [symbol] ϵ {1, . . . , L} refers to the [symbol] RF chain in the antenna array, where L is the total number of antenna elements or RF chains, while the subscript m ϵ {1, . . . , M} refers to the m^{th} NF probe, where M is the total number of NF probes. As will be understood, L and M may represent any number. For simplicity, the following description with respect to the signals transmitted within the system of the disclosure is conducted directly in the frequency domain, however the disclosure may also operate in other domains, such as, but not limited to, the time domain.

For this description, [symbol] represents the beamforming phase of the [symbol] RF chain, and X (ω) is the array input signal, where ω represents an angular frequency. Assuming that the PAS 106 are operating in their linear region (backoff or linearized apriori), the PA output of the [symbol] antenna element or RF chain can be calculated using the following equation (which is used solely for linear signal determination):

$${Y}_{ℓ} ( ω ) = G X ( ω ) {E}_{ℓ} ( ω , {ϕ}_{ℓ} ) {e}^{j {ϕ}_{ℓ}} \qquad ( 1 )$$

where G is the designed PA gain and [symbol] (ω, [symbol] ) is a beamforming phase ( [symbol] ) and frequency (ω)-dependent complex multiplicative error corresponding to the [symbol] RF chain in the antenna array. The error, [symbol] (ω, [symbol] ), (which models the linear distortion in the array) is assumed to be periodic in the phase [symbol] , such that:

$${E}_{ℓ} ( ω , {ϕ}_{ℓ} ) \approx {E}_{ℓ} ( ω , {ϕ}_{ℓ} + π ) \qquad ( 2 )$$

The signal received by the m^{th} NF probe, Zₘ (ω), (used solely for linear signal determination) is then represented by the equation:

$${Z}_{m} ( ω ) = {Σ}_{ℓ = 1}^{L} {β}_{m , ℓ} ( ω ) G X ( ω ) {E}_{ℓ} ( ω , {ϕ}_{ℓ} ) {e}^{j {ϕ}_{ℓ}} \qquad ( 3 )$$

where [symbol] (ω) represents the coupling coefficient between the [symbol] antenna element and the m^{th} NF probe. Rewriting the equation (3) in matrix form (for use solely in linear signal determination) results in:

$${Z}_{m} ( ω ) = G X ( ω ) Φ {B}_{m} ( ω ) E ( ω , ϕ ) \qquad ( 4 )$$

where Φ is the L-length row vector Φ=[e^{jϕ1}, . . . , e^{jϕL}], Bₘ (ω) is an L×L diagonal matrix with [symbol] column and [symbol] row entry equal to [symbol] (ω), and E(ω, ϕ)=[E₁(ω, ϕ₁), . . . , E_{L}(ω, ϕ_{L})]^{T} is the error column vector.

Assuming prior knowledge of the NF coupling coefficients; β_{m,i}(ω) and using a series of L/M measurements with custom phase settings applied to each RF chain in each measurement, the phase-dependent errors [symbol] (ω, [symbol] ) for [symbol] =1, . . . , L can be estimated. These custom-selected phases may be chosen, such that the phase-dependent error, [symbol] (ω, [symbol] ) for the [symbol] chain, remains constant across the different measurements. The phase settings used during calibration are selected as either ϕ or ϕ+π, since by equation (2), these have the same error E(ω, ϕ). The choice between these two settings varies between the L/M measurements and is determined by the Walsh-Hadamard matrix, Hₙ, where, for both linear and non-linear signal determination, is:

$${H}_{n} = [ \begin{matrix}{H}_{\frac{n}{2}} & {H}_{\frac{n}{2}} \\ {H}_{\frac{n}{2}} & - {H}_{\frac{n}{2}}\end{matrix} ] \qquad ( 5 )$$

where H₁=1 and n is a power of 2. It will be understood that other custom-selected phases/magnitude selections are contemplated and are not required to be only based on the Walsh-Hadamard matrix.

Assuming L and M<L are powers of 2, then so is L/M. Therefore, H is the L/M×L matrix H=[H_{L/M} H_{L/M}. . . H_{L/M}] obtained by concatenating the Walsh-Hadamard matrix H_{L/M} M times. Then, the phase setting applied to the [symbol] RF chain during the i^{th} measurement is determined by the entry in the i th row and [symbol] th column of H. If the entry is a 1, then the phase setting is e^{jϕ}; otherwise, the entry is −1, and the phase setting is e^{j(ϕ+π})=−e^{jϕ}. Hence, the applied phase to the [symbol] antenna elements at the i^{th}measurement is given by the entry in the i^{th} row and [symbol] column of e^{jϕ}H. Consequently, if the signals received from the M NF probes are denoted as Zₘ(ω)=[Z_{m,1}(ω), . . . , Z_{m,L/M}(ω)]^{T}, where Z_{m,i}(ω) is the NF received signal (for use in linear signal determination) at the m^{th} NF probe during the i^{th} measurement, then

$$[ \begin{matrix}{Z}_{1} ( ω ) \\ ⋮ \\ {Z}_{M} ( ω )\end{matrix} ] = GX ( ω ) {e}^{j ϕ} [ \begin{matrix}{HB}_{1} ( ω ) \\ ⋮ \\ {HB}_{M} ( ω )\end{matrix} ] [ \begin{matrix}{E}_{1} ( ω , ϕ ) \\ ⋮ \\ {E}_{L} ( ω , ϕ )\end{matrix} ] . \qquad ( 6 )$$

Finally, the error terms, [symbol] (ω, ϕ), in equation (6) can be estimated using least-squares fit. These are then used to calibrate the array or potentially detect faulty antenna elements. With the array now calibrated and operated in its nonlinear region, the [symbol] PA output can now be modeled as follows (for use solely in non-linear signal determination):

$${Y}_{ℓ} ( ω ) = G {V}_{ℓ} ( ω ) {e}^{j {ϕ}_{ℓ}} \qquad ( 7 )$$

where [symbol] (ω)=X(ω)+ [symbol] (ω), and [symbol] (ω) is the [symbol] PA nonlinear additive error. Consequently, the received signal (for use solely in non-linear signal determination) at the m^{th} NF probe can be expressed as follows:

$${Z}_{m} ( ω ) = G Φ {B}_{m} ( ω ) V ( ω ) \qquad ( 8 )$$

where V(ω)=[V₁(ω), . . ., V_{L}(ω)]^{T}. If now a series of L/M measurements (with phase settings derived from the matrix H) is used with ϕ=0, then the received signals may be expressed as follows (for use solely in non-linear signal determination):

$$[ \begin{matrix}{Z}_{1} ( ω ) \\ ⋮ \\ {Z}_{M} ( ω )\end{matrix} ] = G [ \begin{matrix}{HB}_{1} ( ω ) \\ ⋮ \\ {HB}_{M} ( ω )\end{matrix} ] V ( ω ) \qquad ( 9 )$$

The PA nonlinear outputs, V(ω), in equation (9) can then be estimated using least-squares fit. These may then be summed and used to train the DPD function which addresses the non-linear errors.

Therefore, as outlined above, the calculations of the linear signals are used for calibration of the antenna array and the calculations of the non-linear signals are used for digital pre-distortion.

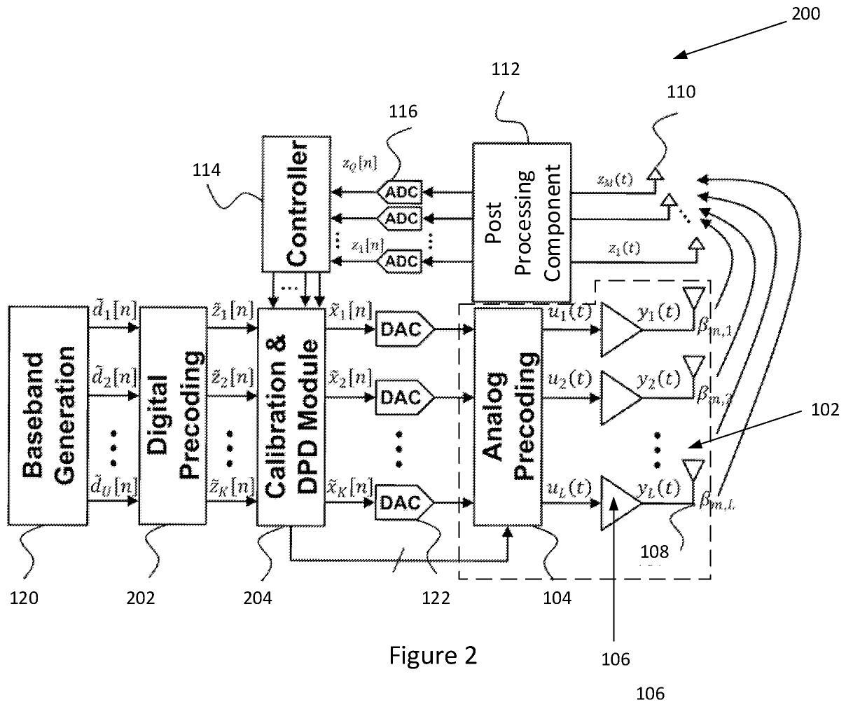

Turning to FIG. 2, a block diagram of another embodiment of a beamforming array system is shown. In the current embodiment, the system 200 includes a fully digital or hybrid beamforming architecture and NF probes for array calibration and linearization.

The beamforming array system 200 includes an RF front-end 102 that includes an analog precoding component 104, a set of power amplifiers 106, and a set of antennas 108. The analog precoder or precoding component 104 may include components such as, but not limited to, power dividers/combiners, gain circuitry and/or phase control circuitry. Positioned in close proximity to the array's antennas 108 are the set of NF probes 110.

The system 200 further includes a post-processing component 112 that provides a connection between the NF probes 110 and the controller 114. Between the post-processing component 112 and the controller 114 are a set of ADCs 116 which may also be integrated within the post-processing component 112 or the controller 114.

The controller 114 is interconnected with or connected to a digital precoder or digital precoding component 202, a calibration and DPD module 204, and the analog precoding component, or analog precoder, 104. A baseband signal generation component 120 is also connected to the digital precoder 202. The calibration and DPD module 204 is connected to the analog precoding component 104 via a set of DACs 112.

In one embodiment, the controller 114 configures the digital precoder 202 and the analog precoder 108 to facilitate the computation of calibration and/or linearization parameters such as discussed above. The controller 114 may also configure the calibration and DPD module 204 along with the analog precoder 104 with the calibration parameters to mitigate or reduce linear distortions within the antenna array 108. The controller 114 may also configure the calibration and DPD module 204 with the linearization parameters, to compensate for nonlinear distortions within the antenna array.

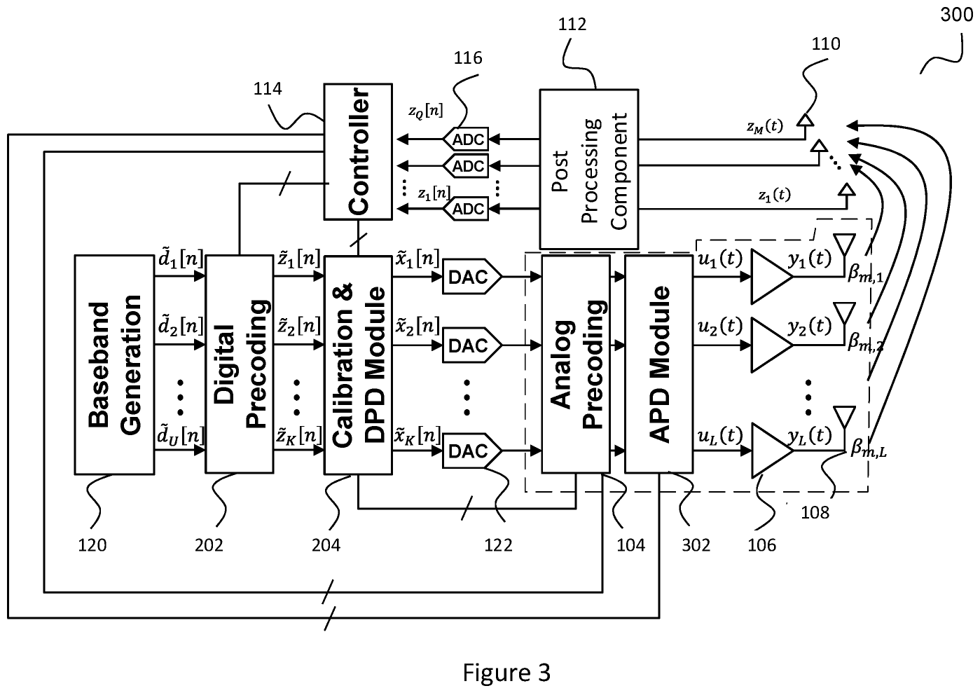

Turning to FIG. 3, a block diagram of another embodiment of a beamforming-based antenna array system is shown. In the current embodiment, the system 300 includes an analog predistortion (APD) module 302.

The beamforming array system 300 includes an RF front-end 102 including an analog precoding network 104, the analog predistortion module 302, a set of power amplifiers 106, and a set of antennas 108. Positioned in close proximity to the set of antennas 108 are the NF probes 110. The system 300 further includes a post-processing component 112 that provides a connection between the NF probes 110 and the controller 114. As with some other embodiments, a set of ADCs 116 are located between the post-processing component 112 and the controller 114.

The controller 114 is interconnected with or connected, the digital precoder 202, the calibration and DPD module 204, the analog precoder 104, and the analog predistortion module 302. A baseband signal generation component 120 is also connected to the digital precoder 202. The calibration and DPD module 204 is connected to the analog precoding component 104 via a set of DACs 112.

In operation, the controller 114 configures the digital precoder 202 and the analog precoder 104 to facilitate the computation of calibration and linearization parameters. The controller 114 may also configures the calibration and DPD module 204 along with the analog precoder 104 with the calibration parameters to mitigate or reduce linear distortions within the antenna array. The controller 114 may also configure the calibration and DPD module 204 and/or the analog pre-distortion module 302 with the linearization parameters to compensate for nonlinear distortions within the antenna array.

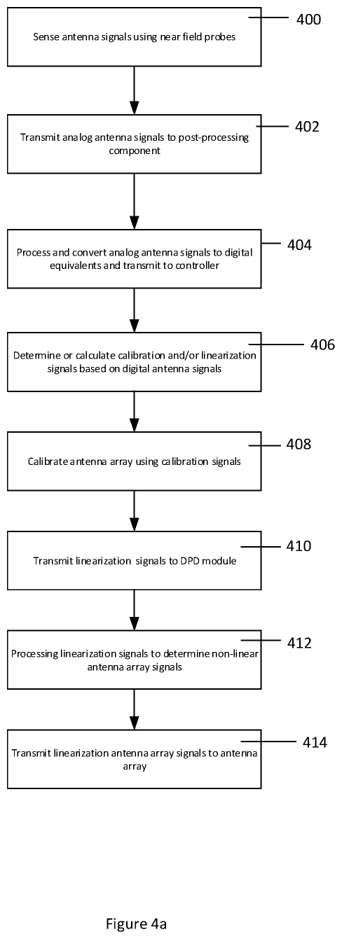

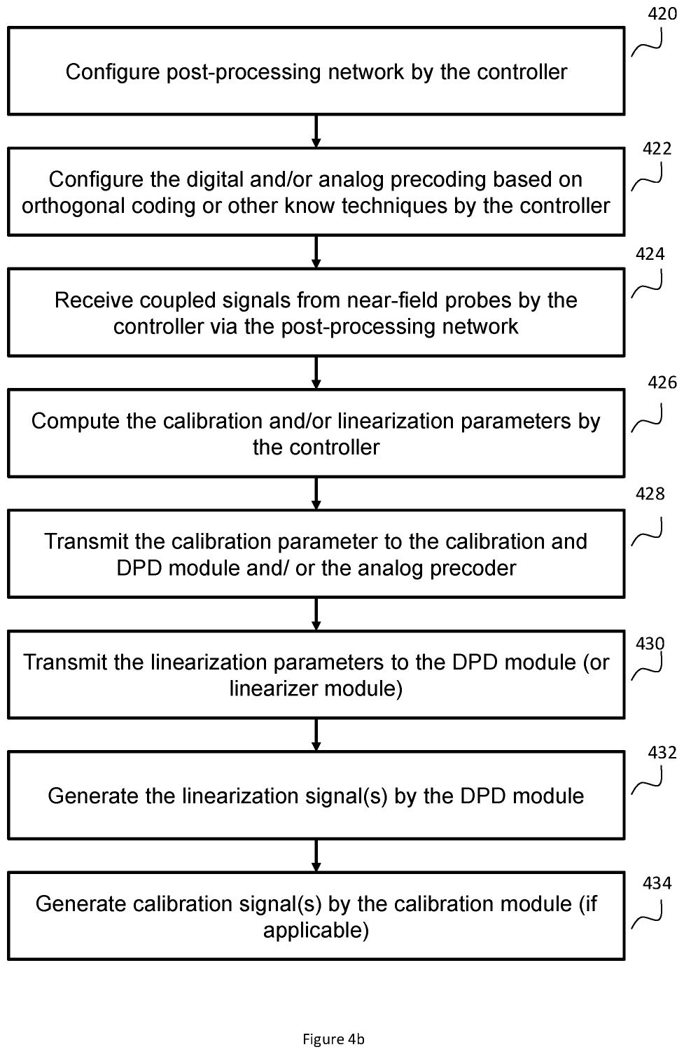

Turning to FIG. 4a, a flowchart outlining a method of calibration and linearization of an antenna array using NF probes is shown. Initially, antenna signals that are radiated by the antenna array, or set of antennas, is sensed by the set of NF probes (400). In some embodiments, the antenna signals are coupled to the NF probes. The analog antenna signals are then transmitted or passed from the NF probes to a post-processing component (402). The analog antenna signals are then converted to their digital equivalents and transmitted to the controller (404). In one embodiment, this may be performed by a combination of the post-processing component and a set of ADCs. In other embodiments, this may be performed by only the post- processing component or only the ADCs. The post-processing component may also process the antenna signals based on instructions from the controller. In some embodiments, either before or after the analog antenna signals are converted from analog to their digital equivalents, the signals may be further processed by the post-processing component to further alter the antenna signals before they are processed by the controller. In some embodiments, the term “antenna signal” may refer to the signals sampled from the antenna elements by the NF field probes and are used for determining the calibration/linearization parameters. In other embodiments, the term “antenna signals” may refer to the near-field received signals which can be post processed by the post-processing network if the latter is not bypassed.

The controller then processes the digital antenna signals to determine or calculate calibration and/or linearization signals or parameters (406). Examples of how these signals may be calculated are discussed above. In some embodiment, the digital antenna signals are compared with expected results to determine if the antenna array is calibrated.

The antenna array is then calibrated via the calibration signals or parameters (408). In one embodiment, the calibration signals or calibration parameters are transmitted from the controller to an analog precoder that is in communication with the set of antennas to control the signals generated by the antennas.

The linearization signals or parameters are then transmitted to the DPD module or component (410). In some embodiments, rather than being performed in sequence after (408), the linearization signals may be transmitted to the DPD at the same time the antenna array is being calibrated.

The linearization signals or parameters are then processed to determine non-linear antenna array control signals (412) which are then transmitted to the analog precoder so that the analog precoder can control the signals generated by the antennas. In some embodiments, the processed linearization signals are transmitted from the DPD module to the APD module.

Turning to FIG. 4b, another flowchart showing another method of calibration and linearization of an antenna array sing NF probes is shown

Initially, the controller configures the post-processing component (420) and the digital and/or analog precoders (422). The digital and/or analog precoders may be configured based on orthogonal coding or other known methodologies. Analog antenna signals are then sensed or coupled to the set of NF probes and digital equivalents of the analog antenna signals are then transmitted to the controller via the post-processing component (424). The digital antenna signals may also be seen as characterization data or a digital representation of characterization data received by the NF probes.

In one embodiment, the analog antenna signals are generated based on known calibration signals from the controller such that the resulting analog antenna signals (or their digital equivalents) or the characterization data should be an expected value.

The controller then processes the characterization data to determine antenna array calibration and/or linearization parameters (426). In one embodiment, the controller compares the characterization data with expected results. If the characterization data is not the same as the expected results, the controller recognizes that further calibration and/or linearization is required in order to adjust the antenna array and determines the antenna array calibration and/or linearization parameters. Examples of how these parameters may be calculated are taught above. The calibration parameters are then transmitted from the controller to the calibration and DPD module and/or the analog precoder (428). The linearization parameters are then transmitted from the controller to the DPD module (430). As discussed above, the linearization signals and the calibration signals may be transmitted at the same time rather than in sequence.

The linearization parameters are then used by the DPD module to generate the pre-distorted signal(s) (432). If needed, the pre-distorted signals are then used to generate updated calibration signal(s) (434). In one embodiment, the methods described in either FIG. 4a or FIG. 4b can be repeated iteratively.

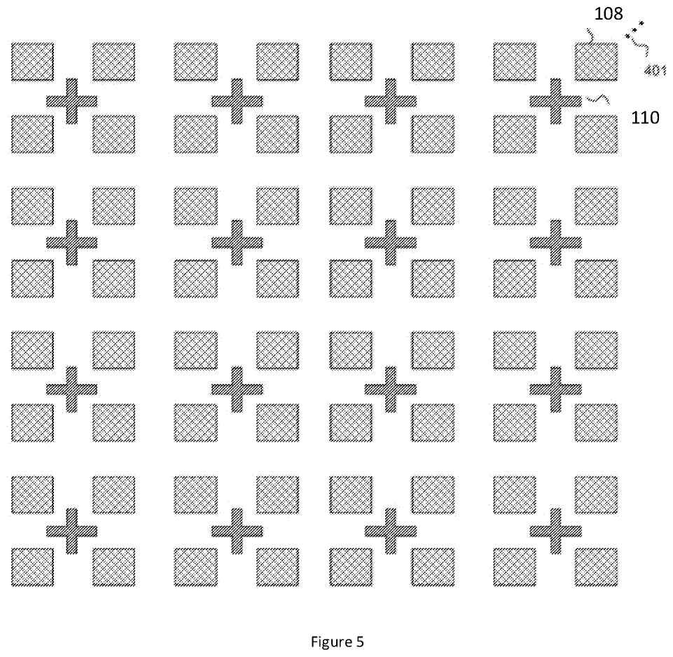

Turning to FIG. 5, a schematic diagram of one embodiment of a set of NF probes embedded within an antenna array is shown. In embodiments, the NF probe(s) may be co-located with the array (e.g., embedded in the array or in the array's vicinity). The NF probes may be distributed uniformly or non-uniformly in the array and may provide flat or frequency-selective coupling to the array's antenna elements.

As shown in the embodiment of FIG. 5 (which may be seen as an example of NF probes embedded in a planar array), the antenna array includes 64 RF chains or antennas 108 that are positioned in an 8×8 array. For each 2×2 sub-section of the antenna array, one of the set of NF probes 100 is embedded or positioned within that sub-section. While the distribution of the NF probes may be done in other setups, for the embodiment of FIG. 5, the distribution of the NF probes is such that there is uniform coupling to the closest antenna elements for each 2×2 sub-antenna array or other sub-antenna array sizes or setups.

After being coupled with its 2×2 sub-section of the antenna array to receive signals from each of the RF chains or antenna elements, the NF probe then feeds the coupled signal(s) to the post-processing component. In certain embodiments, the controller receives the coupled signals from all NF probes via the post-processing component, while in other embodiments, only a predetermined number or a predefined selection of coupled signals from NF probes are received by the controller. The determination of which embedded NF probes transmit their signals may be governed or controlled by the controller 114 and is achieved through the configuration of the post- processing network 112. In some embodiments, the selection may be based on the location and distribution (uniform or non-uniform) of the NF probes.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding.

Embodiments of the disclosure or elements thereof may be represented as a computer program product stored in a machine-readable medium (also referred to as a computer- readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non- volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the embodiments can also be stored on the machine-readable medium. The instructions stored on the machine-readable medium can be executed by a processor or other suitable processing device and can interface with circuitry to perform the described tasks.

The above-described embodiments are intended to be examples only. Alterations, modifications, and variations can be affected to the particular embodiments by those of skill in the art without departing from the scope, which is defined solely by the claims appended hereto.

What is claimed is:

1. An apparatus for active calibration and/or linearization of an antenna array comprising:
a set of near-field (NF) probes located proximate the antenna array to receive analog antenna array signals transmitted by the antenna array; and
a controller for calculating at least one of calibration signals or linearization signals based on digital equivalents of the analog antenna array signals and for controlling the antenna array based on the least one of the calibration signals or linearization signals.

2. The apparatus of claim 1 further comprising:
a processing unit for processing the analog antenna array signals to generate digital equivalents of the analog antenna array signal and to pass the digital equivalents of the analog antenna array signals to the controller.

3. The apparatus of claim 1 further comprising:
an analog precoder for receiving calibration signals to control the antenna array.

4. The apparatus of claim 3 further comprising:
a digital predistortion module for receiving the linearization signals and for generating at least one predistortion signal based on the linearization signals;
wherein the predistortion signal is transmitted to the analog precoder to update the calibration signals.

5. The apparatus of claim 4 further comprising:
a digital precoder.

6. The apparatus of claim 2 wherein the processing unit comprises:
at least one of combiners, dividers, switches, analog-to-digital converters (ADCs) or couplers.

7. A method of active calibration and/or linearization of an antenna array comprising:
receiving, via a set of near-field probes, a set of analog antenna signals; and
calculating at least one of calibration signals or linearization signals based on digital equivalents of the analog antenna array signals and for controlling the antenna array based on the least one of the calibration signals or linearization signals.

8. The method of claim 7 further comprising, after receiving the set of analog antenna signals:
processing the set of analog antenna signals to generate the digital equivalents of the analog antenna array signals.

9. The method of claim 8 further comprising:
transmitting the calibration signals to an analog precoding component to control the antenna array.

10. The method of claim 8 further comprising:
calculating non-linear antenna array signals based on the linearization signals.

11. The method of claim 10 further comprising:
transmitting the non-linear antenna array signals to an analog precoding component to control the antenna array.
